(19) United States
(12) Patent Application Publication
(10) Pub. No.: US 2003/0046415 A1
(43) Pub. Date: Mar. 6, 2003

(54) File transmitting method and system

(76) Inventors: Takahiro Kaijyu, Seto (JP); Takashi Yamagishi, Yokohama (JP); Tetsuo Matoba, Kawabe (JP); Masami Kamiya, Nishio (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/058,778

(22) Filed: Jan. 30, 2002

(30) Foreign Application Priority Data
Aug. 30, 2001 (JP) 2001-261774

(51) Int. Cl. G06F 15/16

(52) U.S. Cl. 709/230

(57) ABSTRACT

An object of the present invention is to transmit and receive a very large file with high reliability and with efficiency using the Internet, which is apt to be unstable, without special operation in a client PC. A file transmitting system according to the present invention is configured as a system in which a client PC 10 is connected via Internet 40 to a processing system comprising a WWW server 20, a management terminal server 30, an AP server 33, and a file server 34. Transmission of file data between a PC and a transfer file 36 of the file server is performed using HTTPS (HyperText Transfer Protocol Secure) that uses a dedicated program. The file data is divided into data having a fixed size, each of which is compressed for transmission. In addition, in preparation for occurrence of a failure, a checkpoint for retransmission is provided for each divided data. The dedicated program is devised so that multi-platform is supported. In addition to it, the dedicated program can be used by downloading it from the server as part of PC operation.

### 2. BACKGROUND OF THE INVENTION

The present invention relates to a file transmission technique, and more particularly to a file transmitting method and a file transmitting system, which perform file transmission between a client PC and a Web server in an Internet environment.

As techniques (related art) relating to file transmission between a client PC and a Web server in an Internet environment, the following methods are known: a method (related art 1) by which file transmission is performed using FTP (File Transfer Protocol); a method (related art 2) by which file transmission is performed by specifying an input form of HTML (HyperText Markup Language); and a method (related art 3) by which file transmission is performed by installing a dedicated program in a client PC to use the dedicated program.

As regards the related art 1, for example, when a local file in a client PC is uploaded to a file in a Web server on an office intranet, in order to enable the upload, it is necessary to set a FW (a fire wall), which is provided in an entrance of the office intranet, so that upload is possible.

As regards the related art 2, in general, because a protocol, which can pass through a FW, is limited to HTTP (HyperText Transfer Protocol) for reasons of its security, file transmission must be realized by specifying an input form prescribed by HTML as the standard.

Moreover, the related art 3 is characterized in that a specific file transmission protocol is tunneled between a client and a server. Therefore, the related art 3 has an advantage that implementing functions, such as divided transmission of file data, in a file transmission protocol permits an application program on the server side to reside in a memory even when a very large file is transmitted, which prevents an increasing load on the server side.

In the related art 1 described above, upload is enabled for the FW to permit upload of FTP from an unspecific IP address. Therefore, there is the following problem: a malicious outsider transmits a large quantity of data, resulting in disk full in a server, which may cause the server to go down.

In addition, as regards the related art 2, file transmission from the client to the server is performed using an original file size as it is. Therefore, the related art 2 has the following problem: as a file becomes larger, a period of time during which an application program on the server side resides in a memory (that is to say, a period of time required for processing of the application program from reading of file data to outputting of the file data) becomes longer, which results in an increasing server load.

Moreover, in the related art 3, a dedicated program, which has the following functions, should be installed in a browser PC beforehand: a function of uploading a file; a function of downloading a file; a function of divided transmission of file data; a function of compressing transferred data; a function of retransmission from a checkpoint at the time of abnormal end of file uploading or file downloading; a function of monitoring a timer; and the like. Therefore, the related art 3 has the following problem: as the dedicated program, those supporting a platform of the client PC must be prepared. Furthermore, the related art 3 has another problem as follows: a dedicated program should be installed for each client PC, causing operation of a user to become troublesome, which hinders the Internet from coming into wider use.

### 3. SUMMARY OF THE INVENTION

An object of the present invention is to provide a file transmitting method and a file transmitting system that can transmit and receive a very large file with high reliability and with efficiency using the Internet, which is apt to be unstable, and using HTTP, which requires no special operation in a client PC, and which comes into widespread use in the world, and more preferably using HTTPS (HyperText Transfer Protocol Secure).

According to the present invention, the object described above can be achieved by transmitting file data using HTTPS, which uses a dedicated program, in a file transmitting method for transmitting the file data between a client and a server via the Internet.

The above description is based on the assumption that the file data is divided into data having a fixed size. In this case, the data is compressed for transmission, and a checkpoint is given to each divided file data. When a failure occurs, using the checkpoint, the file data is retransmitted from the checkpoint.

### 4. BRIEF DESCRIPTION OF THE DRAWING

FIG. 1 is a block diagram illustrating a configuration of a whole file transmitting system according to one embodiment of the present invention;

FIG. 2 is a diagram illustrating settings of an operating environment of a dedicated program;

FIG. 3 is a diagram illustrating downloading of a dedicated program;

FIG. 4 is a flowchart illustrating processing of operating environment settings of a dedicated program in the case of one use of a client PC for one company;

FIG. 5 is a flowchart illustrating processing of operating environment settings of a dedicated program in a client PC in the case of multiple use of the client PC for one company;

FIG. 6 is a flowchart illustrating processing of VR (Version Revision) management of a dedicated program;

FIG. 7 is a flowchart illustrating processing of uploading a file that is transmitted from a client PC to a server;

FIG. 8 is a flowchart illustrating processing of downloading a file that is transmitted from a server to a client PC;

FIG. 9 is a flowchart illustrating processing of file retransmission from a checkpoint when a failure occurs during uploading; and

FIG. 10 is a flowchart illustrating processing of file retransmission from a checkpoint when a failure occurs during downloading.

### 5. DETAILED DESCRIPTION OF THE PREFERRED EMBODIMENTS

Embodiments of a file transmitting method and a file transmitting system according to the present invention will be described in detail with reference to drawings as below.

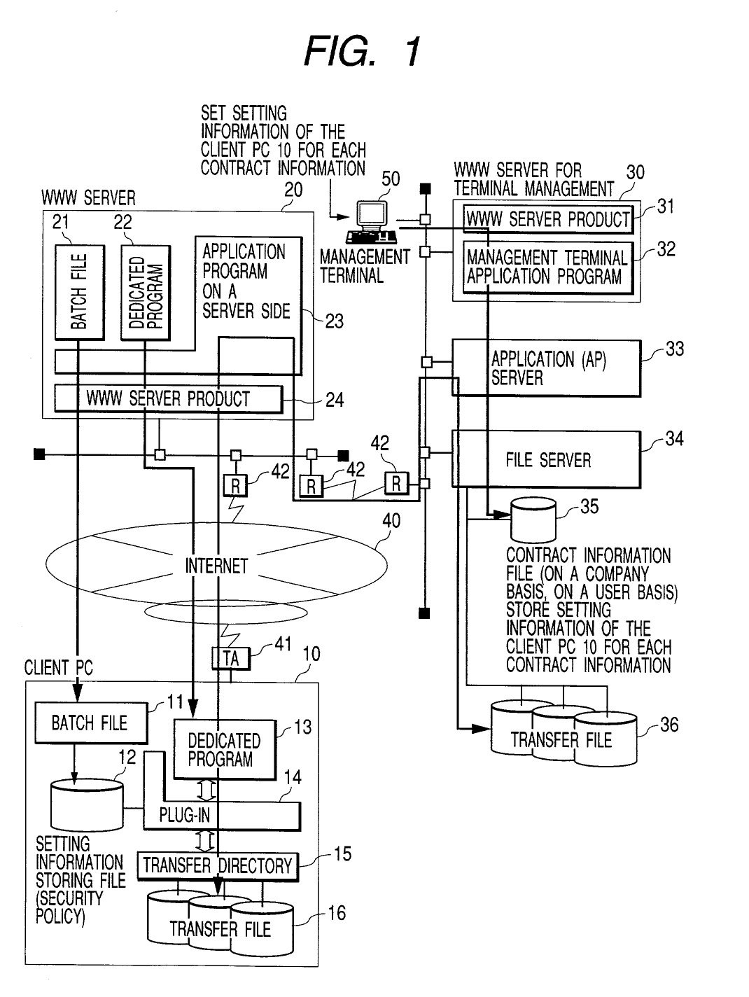

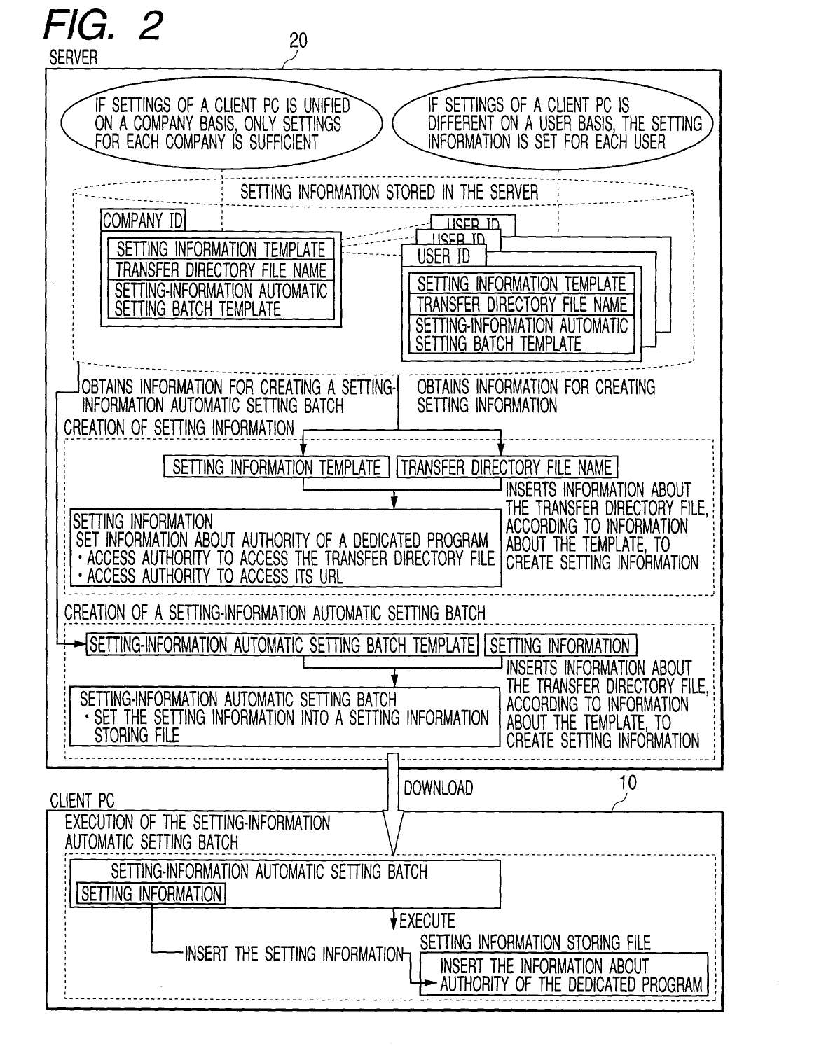

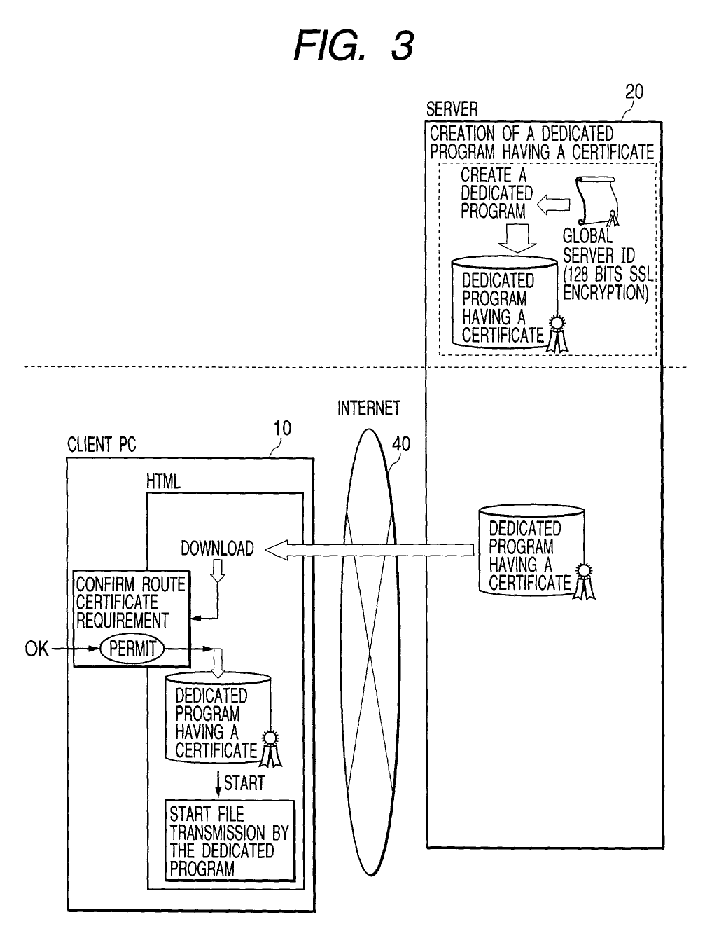

FIG. 1 is a block diagram illustrating a configuration of a whole file transmitting system according to one embodiment of the present invention; FIG. 2 is a diagram illustrating settings of a dedicated program operation environment; and FIG. 3 is a diagram illustrating downloading of a dedicated program. In FIGS. 1 through 3, reference numeral 10 is a client PC; reference numeral 11 is a batch file; reference numeral 12 is a setting information file; reference numerals 13, 22 are dedicated programs; reference numeral 14 is a plug-in means; reference numeral 15 is a transfer directory; reference numerals 16, 36 are transfer files; reference numeral 20 is a WWW server; reference numeral 21 is a batch file; reference numeral 23 is an application program on a server side; reference numeral 24 is a WWW server product; reference numeral 30 is a WWW server for terminal management; reference numeral 31 is a WWW server product, reference numeral 32 is a management terminal application; reference numeral 33 is an application (AP) server; reference numeral 34 is a file server; reference numeral 35 is a contract information file; reference numeral 40 is the Internet; reference numeral 41 is a terminal adapter; reference numeral 42 is a router (R); and a reference numeral 50 is an management terminal.

As shown in FIG. 1, the file transmitting system according to the embodiment of the present invention is configured as a system in which the client PC 10 is connected through a network, such as Internet 40, to a processing system comprising a plurality of servers such as the WWW server 20, the management terminal server 30, the AP server 33, and the file server 34. The plurality of servers, which constitute the processing system, are mutually connected through a network such as a LAN having the router 42. The following files are connected to the file server 34: the contract information file 35, which stores setting information of the client PC 10 for each contract information on a company basis (on a user basis) as a customer that manages the client PC 10; and the transfer file 36 that holds a file used for file transfer with a transfer file possessed by the client PC 10.

The management terminal 50 is connected to the network such as LAN. This management terminal 50 is used to input setting information of a client PC for each contract information, which will be stored in the contract information file 35. The inputted information is stored in the contract information file 35 through the WWW server product 31 and the management terminal application program 32, which are in the management terminal WWW server 30.

The WWW server 20 comprises a batch file 21 that has setting information on operating environment of a dedicated program in the client PC 10; the dedicated program 22 that is downloaded into the client PC 10; the application program on the server side 23; and the WWW server product 24. In addition, the client PC 10 comprises the batch file 11 that receives the setting information from the WWW server 20, and that stores the setting information temporarily; the setting-information storing file 12 that stores operating environment of a dedicated program, security information, and the like; the dedicated program 13 that is downloaded from the WWW server 20; the plug-in it means 14; the transfer directory 15; and the transfer file 16 that holds a file used for file transfer with the transfer file 36 possessed by the file server. The client PC 10 is connected to the Internet 40 through the terminal adapter 41.

The file transfer system, which is configured as described above, is suitable for a case where a large amount of file information such as bank transfer information is transferred between a server system of a financial institution and a company user, for example. The file transfer system is so devised that it is possible to transfer important information such as bank transfer information between the financial institution and the user with high security via the Internet having comparatively low reliability. In this case, the processing system comprising the plurality of servers shown in FIG. 1 is a system that is provided in a financial institution. The client PC 10 is a terminal that is provided in a client company, etc.

Next, functions of the system according to the embodiment of the present invention as described above will be outlined as below.

In the embodiment of the present invention, in order to permit a file, which requires high security, to be transferred reliably, file transmission is realized by using HTTP, which is rarely damaged by hacking, or the like. Because of it, a firewall (FW), which is provided at an entrance of the processing system (not illustrated in FIG. 1), is configured to allow only passage of HTTP. In addition, in order to prevent tapping of file data, which is transmitted and received, a file is transmitted using HTTPS that performs encryption of SSL 128 bits.

In the embodiment of the present invention, in order to perform the file transmission as described above, a dedicated program for that purpose is used, and an operating environment of the dedicated program is set in the client PC beforehand. The dedicated program operating environment is set by downloading setting information (permitting a file access when performing file transmission; and the like), which is used for executing a dedicated program, from a server; and automatically setting the downloaded information to the client PC. The setting information is so devised that it is possible to set a template, which is used to adjust a syntactic difference among operating systems such as UNIX and Windows (trademarks), from outside in order to support multi-platform.

As described above, in order to provide a client with a dedicated program to perform file transmission by the dedicated program, the embodiment of the present invention is so devised that HTTP between a client and a server has a function of tunneling a specific file transmission protocol. This specific file transmission protocol has functions of compressing, dividing, and transferring file data, which improve transmission efficiency. In addition to it, the file transmission protocol is so devised that when dividing and transferring a file, a checkpoint for transmitting the file again at the time of occurrence of a failure is provided to avoid inefficient processing, such as data retransmission from the beginning, in unstable Internet communication. In addition to it, the file transmission protocol is so devised that when dividing and transferring a file, a checkpoint for transmitting the file again at the time of occurrence of a failure is provided to avoid inefficient processing, such as data retransmission from the beginning, in unstable Internet communication. Moreover, besides the functions described above, the following functions are added to the file transmission protocol: VR (Version Revision) management of a dedicated program for a client PC; file uploading; file downloading; timer monitoring; and the like.

The dedicated program is downloaded from a server by a client. However, by adding an electronic certificate to the dedicated program to be downloaded, a manufacturer is identified, which prevents unauthorized rewriting. Additionally, the dedicated program is downloaded as part of user operation so that user's labor is saved.

Moreover, in the embodiment of the present invention, the dedicated program is so devised that multiple platforms are supported. This eliminates the need of having a dedicated program for each platform. Furthermore, the dedicated program is so devised that the dedicated program can be used by downloading it from the server as part of operation of the client PC. This eliminates the need for installing the dedicated program.

Next, how to set an operating environment of a dedicated program will be described with reference to FIG. 2.

In the first place, setting information, which is used for executing the dedicated program, is stored in the server on a company basis or on a user basis together with a company ID and a user ID. If settings of a client PC are unified on a company basis, the stored setting information may be set for each company. If settings of a client PC are different on a user basis, the stored setting information is set for each user. The stored setting information includes the following: a setting information template that describes syntax for defining a transfer directory file, which permits a file access at the time of file transmission; a transfer directory file name that is embedded in the setting information; and a batch template for automatically setting the setting information, as a template of a batch file, which is used for setting the setting information after downloading the setting information to the client PC. These are described in Java (trademark).

When creating the setting information, based on a setting information template of the stored setting information described above, and based on a transfer directory file name, which will be embedded in the setting information, the server inserts information on a transfer directory file, according to information on the setting information template, to create the setting information for setting information on authority of a dedicated program, which includes access authority to access the transfer directory file, and access authority to access its URL.

Then, the server creates a setting-information automatic setting batch. This batch is created by the following processing: based on a setting-information automatic setting batch template of the stored setting information described above, and based on the created setting information, inserting information on the transfer directory file to create a setting-information automatic setting batch, according to information on the setting-information automatic setting batch template; and storing the setting information in a batch file 21 as a setting-information storing file.

The transfer directory name and the URL name as the setting information described above, which are used by the dedicated program, are defined on a company basis or on a user basis on the server side. If the setting information is exemplified, for example, the setting information is expressed as follows:

grant codeBase “http.//XXXXXXXX.co.jp/NetBank/” {permission java.io.FilePermission “C:TEMP-”, “read, write, delete, execute”;

permission java.net.SocketPermission “XXXXXXXX.co.jp”, “accept,

connect, listen, resolve”;};

In this example, underlined parts are the following: a URL name indicating where a dedicated program is stored; a transfer directory file name that permits an access of the dedicated program; and an URL name that permits communication of the dedicated program.

The client PC 10 downloads the setting-information automatic setting batch, which has been created as described above, from the batch file 21 of the server. Then, the client PC 10 executes the batch to insert the information on authority of the dedicated program in a user policy of the setting-information storing file 12 in the own PC.

As a result, the client PC 10 has been set automatically by downloading the setting information, which is stored in the server, before downloading the dedicated program. This means that an environment for downloading and executing the dedicated program has been prepared.

The client PC 10 downloads the dedicated program, and then uses the dedicated program to perform file transmission. In the next place, downloading of the dedicated program will be described with reference to FIG. 3.

When creating the dedicated program, the server adds an electronic certificate to the dedicated program in order to identify a manufacturer of the dedicated program so that unauthorized rewriting is prevented. In this case, the server adds some code, which has been encrypted from a global server ID by means of 128 bits SSL encryption, to the dedicated program. Then, the server stores the dedicated program having the electronic certificate as the dedicated program 22 in the own server.

The dedicated program can be downloaded into the client PC 10 as part of user operation. Because of it, when downloading the dedicated program, the user can obtain the dedicated program, which is stored in the server, as the dedicated program 13 in the own PC only by inputting to instruct “OK” after checking a manufacturer of the dedicated program using a “route certificate requirement confirmation screen”, which eliminates the particular need for troublesome work, that is to say, installation of the dedicated program.

As described above, using the dedicated program, the user can perform file transmission between the transfer file 16 in the own PC 10 and the transfer file 36 of the file server 34 by starting the dedicated program having the certificate, which has been downloaded by the client PC 10.

As described above, in order to provide the client with the dedicated program to perform file transmission by the dedicated program, the embodiment of the present invention is so devised that HTTP between the client and the server has the function of tunneling a specific file transmission protocol. Next, the function will be described.

1. VR (Version Revision) management of a client PC dedicated program

When downloading a dedicated program, the client PC saves the dedicated program on the client PC side temporarily. Therefore, the dedicated program is managed by providing the client PC and the server with a version number of the dedicated program. When the client PC starts the dedicated program, the client PC sends an inquiry about the version number to the server side, and then receives the version number responded from the server. If the responded version number is not equivalent to the version number held by the client PC, the dedicated program of the client PC ends temporarily. After that, a dedicated program having a new version number is downloaded from the server.

2. File uploading

This is a function of uploading a specified file to the server by the client PC. HTTPS is used for communication.

3. File downloading

This is a function of downloading a file into a specified file from the server by the client PC. HTTPS is used for communication.

4. Divided transfer of file data

This is a function of dividing a file to transmit the divided file at definite time intervals when transmitting a file. A size of division and an interval of division are determined by information held on the server side.

5. Compression of transferred data

This is a function of compressing data when transferring a file. Whether or not the data is compressed is determined by information held on the server side, or can be specified by operation before starting file transmission.

6. Retransmission from a checkpoint at the time of abnormal end of file uploading or file downloading

If a failure occurs during file transfer, a state before the failure is held on the server side. This is a function of retransmitting the file. When file retransmission is instructed by the client PC, it is possible to perform transmission from the next data of data that has already been received by the server.

7. Timer monitoring

File transmission is performed based on a response to an inquiry from the client PC. However, if response data is not returned within monitoring time (no reply), the file transmission is terminated.

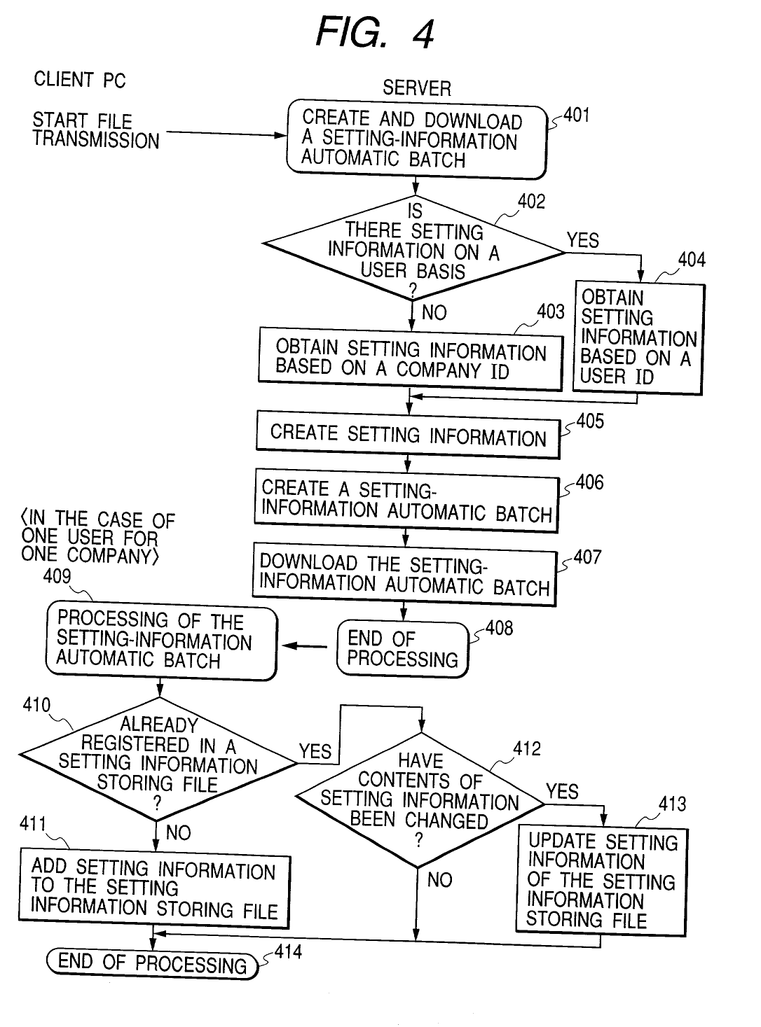

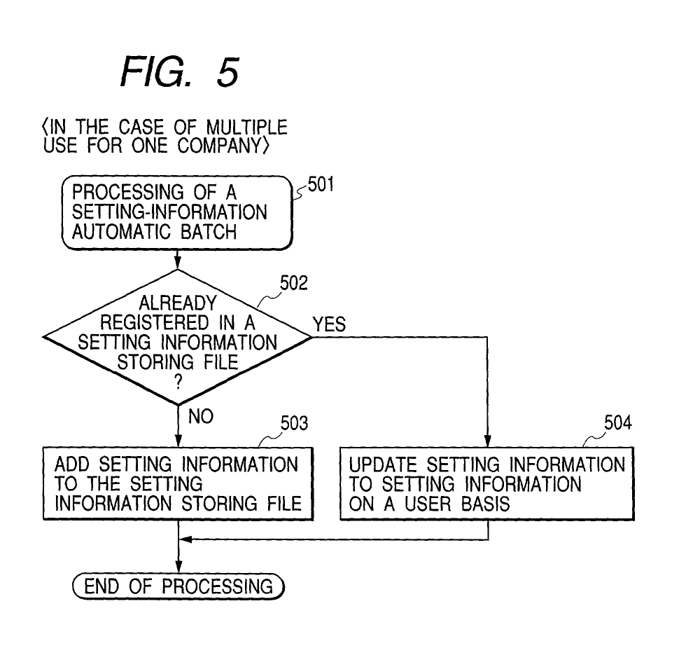

FIG. 4 is a flowchart illustrating processing of operating environment setting of a dedicated program in the case of one use of a client PC for one company. FIG. 5 is a flowchart illustrating processing of operating environment setting of a dedicated program in the case of multiple use of a client PC for one company. Next, the processing will be described. The flowcharts shown in FIGS. 4 and 5 have already been described with reference to FIG. 2. In the first place, the flowchart in FIG. 4 will be described.

(1) When the client PC instructs starting of file transmission, the server receives information such as an ID from the client PC, and then starts creation and downloading of a setting-information automatic setting batch. After that, the server judges whether or not there is setting information on a user basis (steps 401, 402).

(2) As a result of the judgment in the step 402, if there is not setting information on a user basis, setting information on a company ID, which is stored in the server, is obtained. If there is setting information on a user basis, setting information on a user ID is obtained (steps 403, 404).

(3) As described in detail with reference to FIG. 2, the server uses the obtained setting information to create setting information, which will be set in the client PC, and to create a setting information automatic batch (steps 405, 406).

(4) After that, the server downloads a setting information automatic batch into the client PC before ending the processing (steps 407, 408).

(5) Because the setting information automatic batch has been downloaded into the client PC, the processing is moved to the client PC. The client PC starts processing of the setting information automatic batch, and then judges whether or not setting information has already been stored in a setting-information storing file (steps 409, 410).

(6) As a result of the judgment in the step 410, if the setting information has not been stored in the setting-information storing file, the setting information is added to the setting-information storing file before ending the processing (step 411).

(7) As a result of the judgment in the step 410, if the setting information has already been stored in the setting-information storing file, the setting information in the downloaded batch is compared with the setting information in the own PC to judge whether or not contents of the setting information have been changed (step 412).

(8) As a result of the judgment in the step 412, if the contents of the setting information have not been changed, the processing ends without update. If the contents of the setting information have been changed, the setting information of the setting-information storing file in the own PC is updated before ending the processing (step 413).

The processing described above is applied in the case of one use of the client PC for one company. Next, processing in the case of multiple use of the client PC for one company will be described with reference to the flowchart shown in FIG. 5. The flowchart shown here illustrates processing in the client PC after the setting information automatic batch described above has been downloaded.

(1) Because the setting information automatic batch has been downloaded into the client PC, the client PC starts processing of the setting information automatic batch, and then judges whether or not setting information has already been stored in the setting-information storing file (steps 409, 410).

(2) As a result of the judgment in the step 502, if the setting information has not been stored in the setting-information storing file, the setting information is added to the setting-information storing file before ending the processing (step 503).

(3) As a result of the judgment in the step 502, if the setting information has already been stored in the setting-information storing file, the setting information in the setting-information storing file is updated to the setting information on a user basis before ending the processing (step 504).

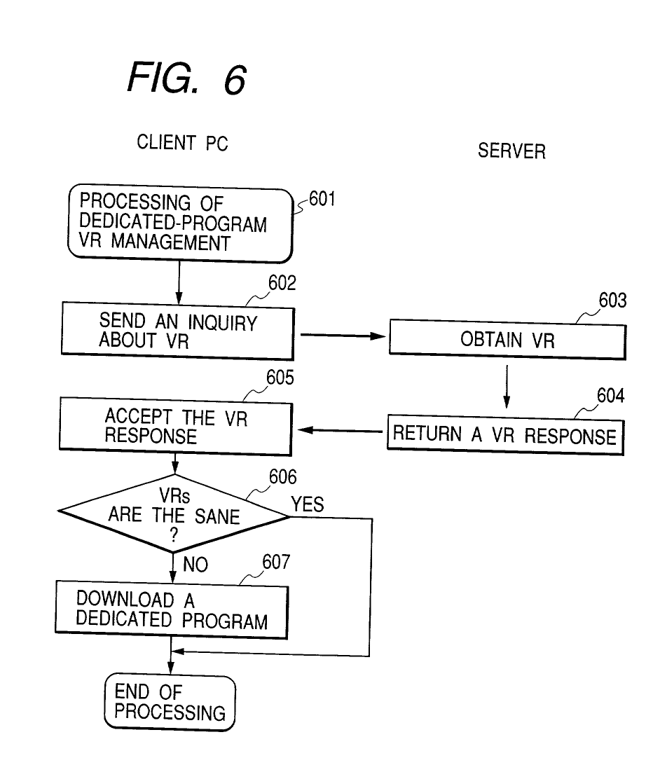

FIG. 6 is a flowchart illustrating processing of VR (Version Revision) management of a dedicated program. The processing will be described as below.

(1) When the dedicated program is started in the client PC and processing of VR (Version Revision) management of the dedicated program is started, the client PC transmits an inquiry about VR (Version Revision) to the server before anything else (steps 601, 602).

(2) When the server receives the inquiry from the client PC, the server retrieves VR (Version Revision) information managed in its own server, and then transmits the VR (Version Revision) information to the client PC as response information (steps 603, 604).

(3) The client PC receives the VR (Version Revision) information as response information, and then judges whether or not VR (Version Revision) information, which is managed in its own PC, is the same as the responded VR (Version Revision) information (steps 605, 606).

(4) As a result of the judgment in the step 606, if both VRs (Version Revision) are the same, the processing here ends. If they are not the same, a dedicated program having a new VR (Version Revision) is downloaded before ending the processing here (steps 606, 607).

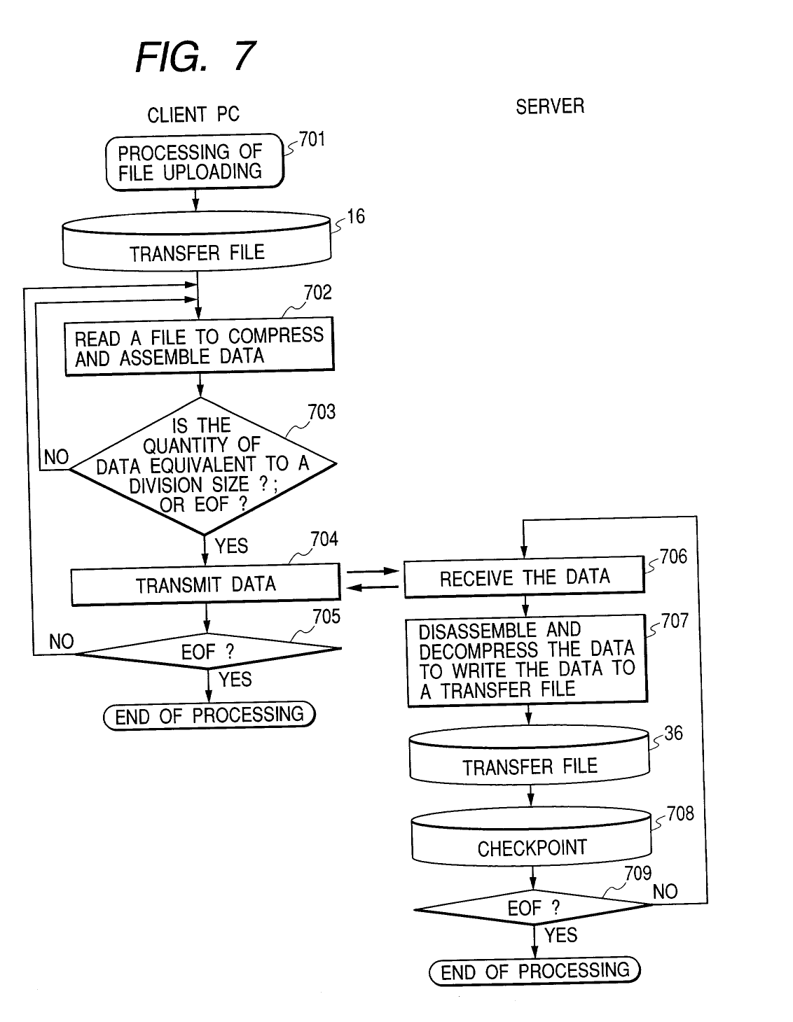

FIG. 7 is a flowchart illustrating processing of uploading a file that is transmitted from the client PC to the server. The processing will be described as below.

(1) When the file upload processing is started in the client PC, a dedicated program in the PC reads a specified file from the transfer file 16 in the PC, and then compresses and assembles data. The processing is repeated until the quantity of the data becomes equivalent to a division size, or until end of file (EOF) included in the file is detected (steps 701 through 703).

(2) In the step 703, if the quantity of the compressed and assembled data becomes equivalent to the division size, or if EOF is detected, the client PC transmits the file data to the server, and then receives a response from the server, indicating that the file data has been received (step 704).

(3) The client PC judges whether or not the transmitted data includes information indicating end of file (EOF). If the information indicating end of file (EOF) is not included, the process returns to the processing of the step 702 to continue processing for the next file information having the division size. If information indicating end of file (EOF) is included, this means that transmission of the specified file has been completed. Therefore, the processing in the client PC ends (step 705).

(4) On the other hand, in the processing of the step 704 described above, the server receives the file data transmitted from the client PC, and then disassembles and decompresses the data to write the data into the transfer file 36 in the own server. In addition to it, the server stores a checkpoint of the data in a checkpoint storing file 708 (steps 706, 707).

(5) The server judges whether or not the file data, which has been stored in the transfer file 36, includes information indicating end of file (EOF). If the information indicating end of file (EOF) is not included, the process returns to the processing of the step 706 to continue receiving the next file data having the division size. If information indicating end of file (EOF) is included, this means that receiving of the whole file has been completed. Therefore, the processing in the server ends (step 709).

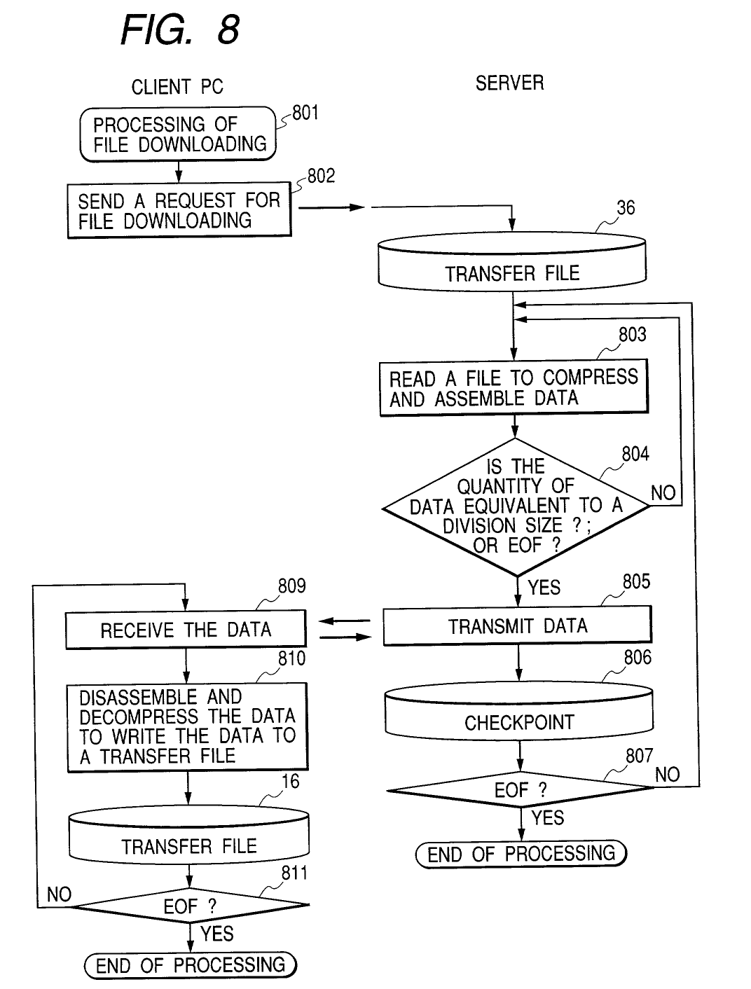

FIG. 8 is a flowchart illustrating file download processing that transmits a file from the server to the client PC. The processing will be described as below.

(1) When the file download processing is started in the client PC, a dedicated program in the PC transmits a request for file downloading to the server, while specifying contents of a file (steps 801, 802).

(2) When receiving the request for downloading this file, the server reads the specified file from the transfer file 16 in the own server, and then compresses and assembles data. The processing is repeated until the quantity of the data becomes equivalent to a division size, or until end of file (EOF) included in the file is detected (steps 803, 804).

(3) In the step 804, if the quantity of the compressed and assembled data becomes equivalent to the division size, or if EOF is detected, the server transmits the file data to the client PC, and then receives a response from the client PC, indicating that the file data has been received (step 805).

(4) After that, the server stores a checkpoint of the transmitted data in a checkpoint storing file 708. Then, the server judges whether or not the transmitted data includes information indicating end of file (EOF). If the information indicating end of file (EOF) is not included, the process returns to the processing of the step 803 to continue processing for the next file information having the division size. If information indicating end of file (EOF) is included, this means that transmission of the whole file has been completed. Therefore, the processing in the server ends (steps 806, 807).

(5) On the other hand, the client PC receives the file data, which has been transmitted from the server in the processing of the step 805, and then disassembles and decompresses the data to write the data into the transfer file 16 in the own PC (steps 809, 810).

(6) The client PC judges whether or not the file data, which has been stored in the transfer file 16, includes information indicating end of file (EOF). If the information indicating end of file (EOF) is not included, the process returns to the processing of the step 809 to continue receiving the next file data having the division size. If information indicating end of file (EOF) is included, this means that receiving of the whole file has been completed. Therefore, the processing in the client PC ends (step 811).

During the file uploading or the file downloading as described above, transmission data, to which a check digit bit is added, is transmitted in order to prevent data missing, and falsification of data. In addition, as checkpoints, division numbers may be given to divided file data sequentially.

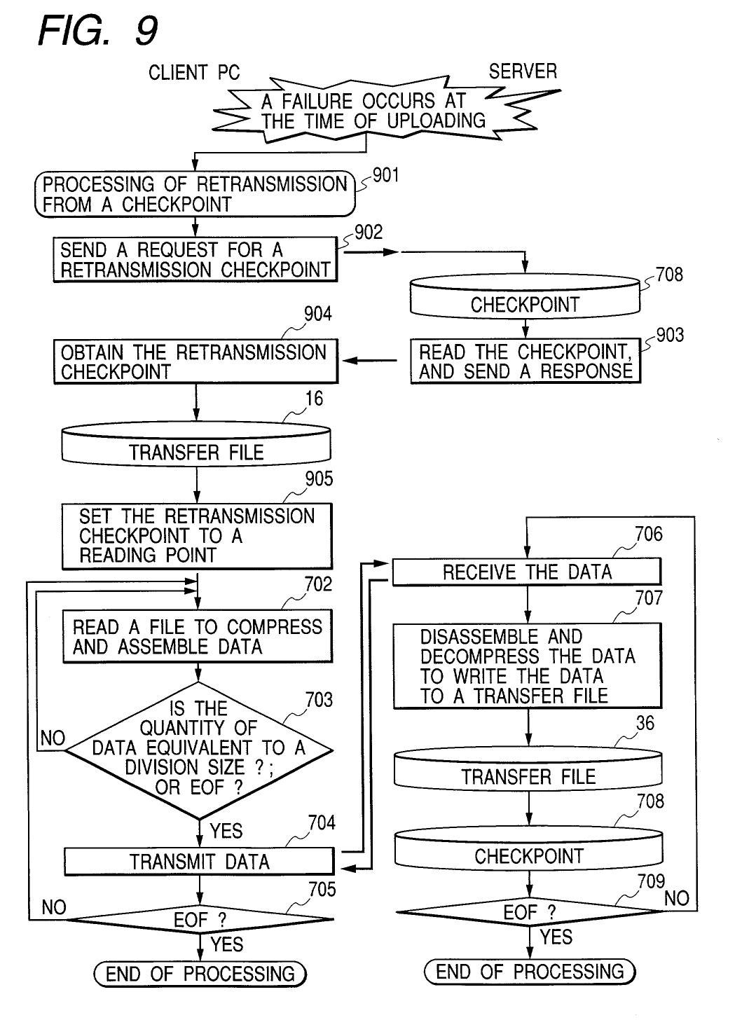

FIG. 9 is a flowchart illustrating processing of file retransmission from a checkpoint when a failure occurs during uploading. The processing will be described as below. The processing for this case is processing performed when a response from the server cannot be received due to occurrence of a failure, or the like, during data transmission after the client PC transmits data and receives the response from the server in the processing of the steps 704, 706 in the flowchart of FIG. 7.

(1) As soon as occurrence of a failure is detected during transmission of file data, the dedicated program of the client PC starts retransmission processing from a checkpoint. To begin with, the dedicated program transmits to the server a request for obtaining a checkpoint to be retransmitted (steps 901, 902).

(2) The server, which has received the request for obtaining the checkpoint, reads the checkpoint from the storing file 708, which stores and manages checkpoints of the file data that has been received before the occurrence of the failure. Then, the server transmits a response to the client PC (step 903).

(3) The client PC, which has received the checkpoint transmitted by the server, could obtain the retransmission checkpoint. Therefore, the client PC sets the retransmission checkpoint to a reading point of the transfer file 16 (step 905).

(4) After that, processing similar to that in the steps 702 through 709 described with reference to FIG. 7 is continued (steps 702 through 709).

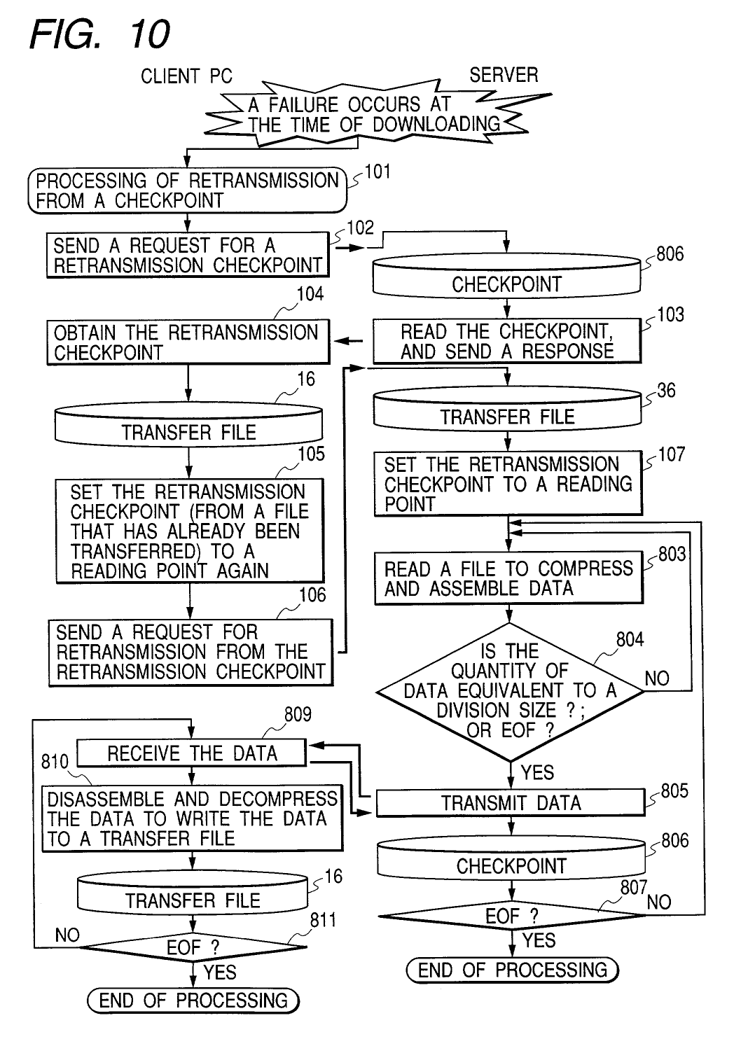

FIG. 10 is a flowchart illustrating processing of file retransmission from a checkpoint when a failure occurs during downloading. The processing will be described as below. The processing for this case is processing performed when data from the server cannot be received due to occurrence of a failure, or the like, during data transmission after the server transmits data and receives the response from the client PC in the processing of the steps 805, 809 in the flowchart of FIG. 7.

(1) As soon as occurrence of a failure is detected during transmission of file data, the dedicated program of the client PC starts retransmission processing from a checkpoint. To begin with, the dedicated program transmits to the server a request for obtaining a checkpoint to be retransmitted (steps 101, 102).

(2) The server, which has received the request for obtaining the checkpoint, reads the checkpoint from the storing file 708, which stores and manages checkpoints of the file data that has been received before the occurrence of the failure. Then, the server transmits a response to the client PC (step 103).

(3) The client PC, which has received the checkpoint transmitted by the server, could obtain the retransmission checkpoint. Therefore, the client PC sets the retransmission checkpoint to a writing point of the transfer file 16 again. After that, the client PC requests the server to retransmit the file data from the retransmission checkpoint (steps 104 through 106).

(4) The server, which has received the request for retransmitting file data, sets the retransmission checkpoint to a reading point of the transfer file 36 (step 107).

(5) After that, processing similar to that in the steps 703 through 811 described with reference to FIG. 8 is continued (steps 702 through 709).

The processing according to the embodiments of the present invention, which was described above, can be performed by constituting a processing program to execute the program. In addition, the processing program can be provided by storing the processing program in recording media such as HD, DAT, FD, MO, and CD-ROM.

The embodiment of the present invention described above produce the following effects: because file data is transmitted using HTTPS, the file data to be transmitted is encrypted, which prevents tapping; and because a network configuration, in which communication via FTP is not allowed, is used, it is possible to prevent attacks against a server from many and unspecified outsiders.

In addition, the embodiment of the present invention described above produce the following effects: because a client PC has a dedicated program for file data transmission, and file data to be transmitted is compressed, transmission speed can be improved; because the file data is divided into data having a fixed size to transmit the divided data, it is possible to adjust a period of time, during which an application program on the server side resides in a memory at a data reception of one time, to within a definite period of time regardless of a file size; and because a checkpoint for retransmission is provided in preparation for occurrence of a failure, it is possible to eliminate the need of transmitting data again from the beginning in communication using unstable Internet.

Moreover, the embodiment of the present invention described above have also an effect of preventing data missing, falsification of data, and the like, because a check digit bit is provided in data during transmission.

In addition, the embodiment of the present invention described above produce the following effects: because a dedicated program is so devised that multi-platform is supported, the need of having the dedicated program for each platform can be eliminated; and because the dedicated program can be used by downloading it from a server as part of operation of a client PC, labor by a user such as installation is not required.

As described above, according to the present invention, using the Internet, which is apt to be unstable, and using HTTPS, which comes into widespread use in the world, and which requires no special operation on a client PC, it is possible to transmit and receive a very large file with high reliability and with efficiency.

1. A file transmitting method by a server, said method using HTTP to transmit file data to a client connected via the Internet, comprising the steps of:
using the HTTP to perform tunneling of a file transmission protocol that is used in a dedicated program;
managing setting information for setting an operating environment, which is used for executing the dedicated program in the client, beforehand;
transmitting the setting information and the dedicated program in response to a request from the client; and
transmitting the file data using the dedicated program, according to the setting information.

2. A file transmitting method according to claim 1, wherein:
the setting information is transmitted to the client as a batch file.

3. A file transmitting method according to claim 1, wherein:
the file data to be transmitted is divided into data having a fixed size, and the data is compressed.

4. A file transmitting method according to claim 3, wherein:
a checkpoint is given to the divided file data; and when a failure occurs, the checkpoint is used to retransmit the file data from the checkpoint.

5. A file transmitting method according to claim 1, wherein:
the dedicated program is so devised that multi-platform is supported; and
the dedicated program is downloaded from the server as part of operation of the client.

6. A file transmitting method according to claim 5, wherein:
an electronic certificate, which identifies a manufacturer, is added to the dedicated program.

7. A file transmitting method by a client, said method using HTTP to transmit file data to a server connected via the Internet, comprising the steps of:
using the HTTP to perform tunneling of a file transmission protocol, which is used in a dedicated program, from the server in response to an instruction to transmit the file data to the server;
receiving setting information for setting an operating environment, which is used for executing the dedicated program;
making a first judgment whether or not the setting information has already been stored;
if the setting information has already been stored, making a second judgment whether or not contents of the setting information has been changed;
updating the setting information in response to results of the first and the second judgment; and
transmitting the file using the dedicated program, according to the setting information.

8. A file transmitting system for transmitting file data between a client and a server via the Internet, comprising:
a dedicated program that uses HTTPS to transmit the file data; and
setting information for setting an operating environment, which is used for executing the dedicated program.

9. A file transmitting system according to claim 8, wherein:
the dedicated program is so devised that multi-platform is supported; and
an electronic certificate, which identifies a manufacturer, is added to the dedicated program.

10. A file transmitting system according to claim 8, wherein:
at least one of a version management function of the dedicated program, a file uploading function, a file downloading function, a function of divided transmission of file data, a function of compressing transferred data, a function of retransmission from a checkpoint, a function of monitoring timer is implemented in the HTTPS.

11. A file transmitting system according to claim 8, wherein:
setting information, which is used for executing the dedicated program, is downloaded from the server to the client.
